(19) United States
(12) Patent Application Publication
(10) Pub. No.: US 2025/0245772 A1
(43) Pub. Date: Jul. 31, 2025

(54) SELF-SUPERVISED IMAGE EMBEDDINGS

(71) Applicant: X Development LLC, Mountain View, CA (US)

(72) Inventors: Diosdado Banatao, Los Altos Hills, CA (US); Daniel Rosenfeld, Mountain View, CA (US); Aleksandra Spyra, Mountain View, CA (US); Alexander Holiday, Brookfield, WI (US); Anna Parfenuk, Brookfield, WI (US)

(73) Assignee: X Development LLC, Mountain View, CA (US)

(21) Appl. No.: 19/035,680

(22) Filed: Jan. 23, 2025

Related U.S. Application Data
(60) Provisional application No. 63/625,668, filed on Jan. 26, 2024.

(51) Int. Cl. G06T 1/00; G06V 10/764

(52) U.S. Cl. CPC G06T 1/0021; G06V 10/764

(57) ABSTRACT

The present disclosure relates to a method and system for acquiring and processing large unlabeled dataset of images to train an embedding model using a self-supervision technique, which may then be used to generate image embeddings with reduced dimensions for any downstream task or model. The downstream model can be a simple model and can be trained efficiently using a small, labeled training dataset as the embedding model may distill important information from the images of the small, labeled training dataset. According to present disclosure, the downstream task or model may include predicting a material category or quantity of a target material of interest in an image that captures (part or all of) one or more objects on a feedstock or a waste stream. In some instances, the image may correspond to a hyperspectral image that is collected using a camera system.

### CROSS-REFERENCE TO RELATED APPLICATIONS

This application claims the priority to and the benefit of U.S. Provisional Application No. 63/625,668, filed on Jan. 26, 2024, entitled “Self-Supervised Image Embeddings”, which is hereby incorporated by reference in its entirety for all purposes.

### BACKGROUND

In the context of machine learning, an ‘embedding’ is a numerical representation (a vector of floating-point values) of some concept that is designed so that concepts that are more similar are closer together in an embedding space, relative to a distance between positions of embeddings of two less similar concepts (mathematically, an L2 distance is typically used to quantify distances). For example, one can represent words using embeddings, and a well-designed embedding model would represent the word ‘cat’ with a vector relatively close to the embedding for ‘dog’, compared to the embedding for ‘car’.

Images can also be embedded. As an example, each 64×64-pixel image may be mapped to a vector of, for example, 128 floating point values. In this context, a well-trained embedding model can be considered an efficient lower-dimensional representation, or compression, of the full image if the embedding somehow captures the important information contained in the image (e.g., the object is blue, bottle-shaped, transparent, and composed of a particular type of plastic). In this case, the amount of information that would be stored is reduced from 64×64×3 floats to 128, which amounts to a reduction of approximately 99%.

However, much of the previous work on image embeddings has focused on (red, green, blue) RGB images and face difficulties with training models based on limited training data.

### SUMMARY

Some embodiments of the present disclosure relate to use of an image of an object on a feedstock or a waste stream to predict a material category or quantity of a target material of interest in the object. A computer-implemented method includes accessing the image of at least part of the feedstock. The image may correspond to a hyperspectral image that is collected using a camera system.

An embedded representation of the image may be generated by processing the image with the embedding model. The axes of the embedded representation in an embedding space can be identified during a training process of the embedding model. The training process uses a self-supervision technique that may process multiple portions of various images in a training data set and that may use a reward function or a loss function. The reward function or loss function can be a contrastive loss. The reward function may be configured such that a reward correlated with an extent to which various portions from individual images are positioned relatively close to each other as compared to or relative to portions from different images in the embedding space.

A predicted contribution variable may be generated by processing the embedded representation using a machine learning model. The predicted contribution variable may predict whether a given material or chemical is present in objects depicted in at least part of the image. The predicted contribution variable may further predict a relative or absolute amount of the given material or chemical in the objects depicted in at least part of the image. The predicted contribution variable may be output, for example, to store in a database, to display on a user interface, or to instruct a sorting machine to divert the object on the feedstock into appropriate storage bin.

In some instances, the machine learning model may include a linear classifier. The given material or chemical may include ethylene vinyl alcohol (EVOH). The predicted contribution variable may predict whether the image of at least part of the feedstock includes plastic or an extent to which the at least part of the feedstock includes plastic. In some instances, the predicted contribution variable may predict whether the image of at least part of the feedstock includes plastic or an extent to which the at least part of the feedstock includes metal. In some other instances, the predicted contribution variable may predict whether the image of at least part of the feedstock includes plastic or an extent to which the at least part of the feedstock includes fibers.

In some embodiments, a system is provided that includes one or more data processors and a non-transitory computer-readable storage medium containing instructions which, when executed on the one or more data processors, cause the one or more data processors to perform part or all of one or more methods disclosed herein.

In some embodiments, a computer-program product is provided that is tangibly embodied in a non-transitory machine-readable storage medium and that includes instructions configured to cause one or more data processors to perform part or all of one or more methods disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates an example overview of a system implemented to detect or sort different materials on a feedstock in accordance with some embodiments of the present disclosure.

FIG. 2 illustrates an example pipeline to process a hyperspectral image to achieve distillation of information and dimension reduction for a downstream model in accordance with some embodiments of the present disclosure.

FIG. 3 shows an example illustration of a self-supervised training or pretraining of an embedding model using a large unlabeled dataset of images in accordance with some embodiments of the present disclosure.

FIG. 4 shows an illustrative example of predicting a material category or composition of an object based on the hyperspectral image of the object in accordance with some embodiments of the present disclosure.

FIG. 5 shows a confusion matrix indicating performance of a machine learning model for classification of the material category in accordance with an example implementation of the present disclosure.

FIG. 6 shows an example flowchart of the system for detecting a given material and/or predicting a contribution of the given material in an image of a feedstock in accordance with some embodiments of the present disclosure.

### DETAILED DESCRIPTION

Disclosed embodiments of the present disclosure relate to a method and system for acquiring and processing large unlabeled dataset of images to train an embedding model using a self-supervision technique, which may then be used to generate image embeddings with reduced dimensions for any downstream task or model. The downstream model can be a simple model and can be trained efficiently using a small, labeled training dataset as the embedding model may distill vital information from the images of the small, labeled training dataset. According to present disclosure, the downstream task or model may include predicting a material category or quantity of a target material of interest in an image that captures (part or all of) one or more objects on a feedstock or a waste stream. In some instances, the image may correspond to a hyperspectral image that is collected using a camera system.

When plastic objects on a conveyor belt pass beneath a sensor pod, the camera system comprises one or more imaging devices (e.g., one or more hyperspectral cameras, RGB cameras, line scanners, etc.) captures images of the object. This creates a large dataset of unlabeled image data (e.g., hyperspectral image data, RGB image data, line-scanner data, etc.). In some instances, an embedding model designed for RGB images can be adapted to the hyperspectral domain using techniques such as SimCLRv2 (see arXiv: 2006.10029, available at https://arxiv.org/abs/2006.10029, which is hereby incorporated by its entirety for all purposes). An adapted model (or the embedding model) can then be used to generate new image embeddings (e.g., new hyperspectral image embeddings).

Advantageously, the embeddings are produced using a technique called self-supervision, which does not require explicit labels. For example, various portions can be cropped from an image (e.g., using a systematic, random, or pseudo-random technique). These portions can be embedded and used to train the embedding model in such a way that the crops from the same image are mapped close together, while crops from different images are mapped further apart (which is illustrated at https://github.com/google-research/simclr, which is hereby incorporated by reference for all purposes). Through this process, the embedding model learns a useful embedding for each image.

Further, ethylene vinyl alcohol (EVOH) is a polymer commonly used in multilayer plastic food packaging to impart an oxygen barrier, preserving food for longer periods of time. EVOH is usually avoided in recycling operations as it may function as a contaminant or foreign material and/or produce contaminants during recycling. Therefore, to be able to detect the presence of an EVOH layer in a piece of waste plastic can be valuable so that EVOH can be diverted away from recycling processes that are intolerant to it, or tolerant to a specific quantity.

Quantifying the presence of EVOH in a piece of plastic is time consuming, as each sample is analyzed using differential scanning calorimetry (DSC), which may take around one hour per piece of plastic. Thus, collecting labeled training data for an EVOH classification model is an expensive prospect, increasing the need for an efficient method of identifying promising pieces of plastic to add to the training set. It is not evident, visually, which samples do and do not contain EVOH. In some embodiments of the present disclosure, embeddings can be used in two distinct phases of development of the EVOH classification model: to identify additional samples (e.g., from the images of the waste stream or feedstock) for labeling (e.g., via DSC), and to build or train the EVOH classification model based on the embeddings.

Some embodiments disclosed herein use embeddings (e.g., hyperspectral embeddings) to suggest new candidates for labeling. This is accomplished by embedding the images of the small set of known EVOH samples, embedding other (e.g., tens of thousands) of other unlabeled images corresponding to other pieces of plastic, and ranking the unlabeled images based on their embeddings' proximity to the embeddings of known EVOH samples. In one experiment, 20% of the images were predicted to include at least one layer (compared to ˜1% overall rate of EVOH in plastic). This can facilitate constructing a varied set of labeled EVOH positive examples.

After the training set for EVOH classification is completed, the embeddings can be used to train the EVOH classification model. First, the images of labeled samples (i.e., the images that are confirmed to have or not have EVOH based on their DSC results) are embedded using the embedding model. Afterwards, a linear classifier can be built on top of these embeddings. This allows training useful models within minutes, compared to the 30 or more hours that may be utilized by a traditional model using the full image data (or hyperspectral image). The performance of this embedding-based EVOH classifier model has been verified on a conveyor system in Salem, Oregon.

In one example, embeddings may be used to classify an object's material type into three categories: plastics, metals, and fibers (e.g., cardboard). The embeddings still provide the benefit of accelerated training speeds, and the classification model can be trained using smaller labeled datasets, enabling faster model iteration. Similar to the EVOH classification model above, images of objects of known material category can be embedded using the embedding model, and then a simple material-category classifier may be built on these embeddings. Hence, the development of the machine learning model for a given downstream task can be greatly simplified by the use of embeddings. While larger models may need over a day to train on dedicated virtual machines, the embedding based models may take few minutes to hours for training and can be evaluated in Jupyter notebooks, enabling much faster experimentation.

According to present disclosure, other classifications may be performed in addition or instead of classifying between plastics, metals, and fibers classes. For example, a set of potential classes may include specific additives, specific fillers, additives (in a general sense), fillers (in a general sense), multi-layered plastics, textiles, composite materials (i.e., electronics), organic materials, specific organic materials, specific chemicals, specific particles. For example, a classification may be performed to predict whether a feedstock includes at least a threshold amount of calcium carbonate. As another example, a classification may be performed to predict whether a feedstock includes at least a threshold amount of TALC.

Some embodiments disclosed herein that use embeddings to represent at least part of images provide compression that distills the important aspects of an image into a small vector, allowing models to be trained using these embedded representations instead of the larger, full images. This accelerates training in three ways:

Firstly, the size of the training data on disk is significantly smaller, given the differences between the full images and their embeddings outlined above. The smaller the data, the faster it loads into memory and the faster training can proceed; thus, training over one hundred gigabytes (GB) worth of full images will generally be much slower than embedding them and training on the resulting one GB dataset.

Secondly, the models can be significantly simpler because the embedding model has distilled the important information into a more efficient form. When training is performed directly on full images, a model has to learn from scratch which parts of an image correspond to an object of interest, to the image background, and to noise. The embedding model does much of this pre-processing itself. For example, a model used to classify cats and dogs using embedded representations of images can be much less sophisticated than a model trained on full images of cats and dogs. Less sophisticated models are smaller and therefore train more quickly.

Thirdly, the models require less data to train, reducing the time for manually label images. For example, instead of learning “from scratch” what a cat and a dog look like by being presented with thousands of labeled cat and dog images, the embedding model already has some understanding of cats and dogs and needs only a few labeled examples to learn the distinction.

According to present disclosure, hyperspectral images can benefit even more from the embedding approach, since the hyperspectral images are significantly larger than three-channel RGB images. Some cameras can produce hyperspectral images with 154 channels. Even if the size of the embedding vector is increased to double (e.g., 256 as compared to 128), the reduction in the size of an image is approximately 99.96% (64×64×154 vs. 256).

Some embodiments disclosed herein may use a model which is trained on the embeddings further capitalize on the above-mentioned advantages, as even less labeling of training data is needed to learn in an embedding space.

According to some aspects of the present disclosure, when the embedding approach is used with RGB images as described above, some classification tasks that are objectively difficult can become tractable or simpler. In sorting objects based on color, an object is imaged on a conveyor system. One simple way to measure color is to use red, green, and blue pixel responses across the image and to calculate the color of the object using a human designed function either directly or through color space transformations. A simple example would be to take the average hue (a color space descriptor indicative of the color, independent of the brightness) across the image. However, when the object is partially obscured, or has labels and stickers on it (such as lightweight packaging waste) the pixel responses may not be indicative of the color of the partially obscured object. The obscured object likely represents most of the mass of the object and therefore it is valuable to know the color of this object and not the color of stickers or labels that are obscuring it. This is especially true as the amount of obscuration increases and, in many cases, can exceed 50% of the object (which may completely defeat the average color calculation described above).

The embedding approach can simplify this task by projecting the high dimensionality RGB image into a feature space that encodes both spatial and pixel color response values into one single vector. As the space/color correlations are represented in the embedding space, a model learned on top of these features can predict classes that depend on non-human-designable mappings from space and color relations to assigned color classes.

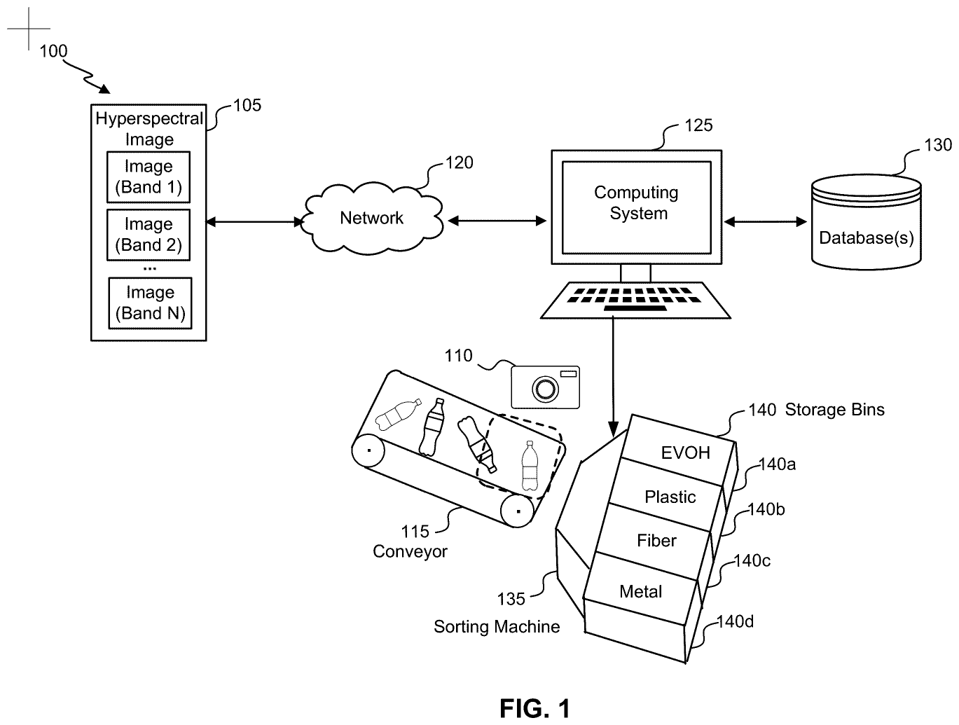

FIG. 1 illustrates an example overview of a system 100 implemented to detect or sort different materials on a feedstock in accordance with some embodiments of the present disclosure. System 100 includes a camera system 110 for capturing images (e.g., hyperspectral images) or line scans (e.g., hyperspectral line scans) of objects. Each image may be of part or all of one or more objects that are being moved by a conveyor belt 115. The objects may include those that were initially collected from multiple individuals' recycling bins.

It will be appreciated that an image or a line scan collected by the camera system 110 and analyzed may include a non-hyperspectral image, and disclosures herein that refer to a hyperspectral image 105 may be adapted to use non-hyperspectral image. For example, the camera system 110 may include a lens with low absorption in the visible range, near infrared range, short-wave infrared range, or mid-wave infrared range. Thus, the captured image may depict signals in the visible range, near infrared range, short-wave infrared range, or mid-wave infrared range, respectively. The camera system 110 can include any of a variety of illumination sources, such as a light emitting diode (which may be synchronized to the camera sensor exposure), incandescent light source, laser, and/or blackbody illumination source. A light emitting diode included in the camera system 110 may have a peak emission to coincide with a peak resonance of a given chemical or material of interest (e.g., a given type of plastic) and/or a bandwidth that coincides with multiple molecular absorptions. In some instances, multiple LEDs can be included in the camera system 110, such that a given specific spectral region can be covered. LED light sources can provide coherent light, and controlling emission and signal to noise may be more feasible than for other light sources. Further, they are generally more dependable and consume less power relative to other light sources.

In some instances, the camera system 110 may be configured such that an optical axis of a lens or image sensor of the camera is between 75-105 degrees, 80-90 degrees, 85-95degrees, 87.5-92.5 degrees, 30-60 degrees, 35-55 degrees, 40-50 degrees, 42.5-47.5 degrees, or less than 15 degrees relative to a surface supporting the object(s) being imaged (e.g., the conveyor belt 115). In some instances, the camera system 110 may be comprised of multiple cameras, where an angle between an optical axis of a first camera relative to a surface supporting the object(s) is different than an angle between an optical axis of a second camera relative to the surface. The difference may be (for example) at least 5 degrees, at least 10 degrees, at least 15degrees, at least 20 degrees, at least 30 degrees, less than 30 degrees, less than 20 degrees, less than 15 degrees, and/or less than 10 degrees. The difference may facilitate detecting signals from objects having different shapes or being positioned at different angles relative to an underlying surface (e.g., having different tilts). In some instances, a first camera may filter a different type of light relative to a second camera. For example, a first camera may be an infrared camera, and a second camera may be a visible-light camera. In some instances, the camera system 110 includes a light source that is in a specular reflection condition relative to the camera and a second light source in a diffuse reflection condition relative to the camera (e.g., to facilitate detecting objects with different specular and diffuse reflectance).

The camera system 110 may include a light guide (e.g., of a fiber-optic, hollow, solid, or liquid-filled type) to transfer light from an illumination source to an imaging location, which can reduce heat released at the imaging location. The camera system 110 may include a type of light source or light optics such that light from the light source(s) is focused to a line or is focused to match a projected size of an entrance slit to a spectrograph. The camera system 110 may be configured such that an illumination source and imaging device (camera) are arranged in a specular reflection condition (so as to generate a bright-field image), in a non-specular (or diffuse) condition (so as to generate a dark-field image), or a mixture of the conditions.

Hyperspectral image 105 usually has image data for each of several or even dozens of wavelength bands depending on the imaging technique. In many applications, it is desirable to reduce the number of bands in a hyperspectral image 105 to a manageable quantity because processing images with high numbers of bands is computationally expensive (resulting in delay in obtaining results and high power use), because the high dimensional space may prove infeasible to search or have unsuitable distance metrics (“the curse of dimensionality”), or because the bands are highly correlated (“the problem of correlated regressors”). Many different dimensionality reduction techniques have been presented in the past such as principal component analysis (PCA) and pooling. However, these techniques often still carry significant computational cost, require specialized training, and may not provide good accuracy in applications such as image segmentation or material category classification. In addition, many techniques still attempt to use most or all bands for segmentation decisions, despite the different wavelength bands often having dramatically different information value for segmenting different types of boundaries (e.g., boundaries of different types of regions having different properties, such as material, composition, structure, texture, etc.). This has traditionally led to inefficiency of processing image data for more wavelength bands than are needed for a segmentation analysis. It has also limited accuracy as data for bands that have low relevance to a segmentation boundary obscure important signal in the data with noise and marginally relevant data.

According to some aspects of the present disclosure, a deep learning model (e.g., an embedding model) may be trained from the scratch or fine-tuned (previously trained on RGB images) on the hyperspectral images by utilizing a self-supervised learning technique such as SimCLRv2 (see arXiv: 2006.10029, available at https://arxiv.org/abs/2006.10029, which is hereby incorporated by its entirety for all purposes). The training, testing, or deployment of the deep learning model or the embedding model may be performed on a computing system 125. Once trained, the embedding model may then be used to generate embeddings of hyperspectral images and thus providing dimensional reduction and/or distillation of information from image data by extracting important patterns or characteristics that represent the content of the image, while reducing irrelevant or redundant information. The embeddings can be used to generate simple or less complex machine learning models for accurate classification of materials category or prediction of material composition in a computational efficient manner, in less time, and with low memory utilization.

In some embodiments, the computing system 125 may initially use a segmentation model (or a segmentation machine-learning model) to process image data to predict segmentation data. The segmentation data may include a predication as to which data points in the image data depict or represent points or voxels within each of multiple individual objects (or do not represent any objects). For example, if image data corresponds to a static two-dimensional physical space (e.g., and to multiple wavelength bands), the segmentation data may identify various portions within the two-dimensional space in which a given corresponding object is located. To illustrate, the segmentation data may identify, for example, across a two-dimensional grid, a value for each point in the grid, where the value identifies an identifier (e.g., which may be generated using an incremental or pseudorandom technique) of an object predicted as being depicted in the pixel. If it is predicted that no object is depicted in the pixel, a default value (e.g., 0 or a not-a-number value) can be assigned. The segmentation and/or one or more other actions may be performed in accordance with one or more disclosures in U.S. application Ser. No. 17/811,766, which was filed on Jul. 11, 2022, which is hereby incorporated by reference in its entirety for all purposes.

In some instances, an image has two dimensions that represent spatial dimensions (e.g., corresponding to a width and length axis) and another dimension that represents different wavelength (or frequency) bands. In some instances, an image is generated based on a set of line scans (e.g., where each line scan may generate an output that identifies an intensity for each position along one spatial dimension and for each of multiple wavelength bands). For example, a line scan can be generated by scanning across a width dimension of the conveyor belt 115 (e.g., for each of the multiple wavelength bands). The conveyor belt 115 may be moving, such that a next line scan is scanning different materials. Multiple line scans can then be combined to generate an image that corresponds to two different dimensions (e.g., and multiple frequency bands).

Thus, for each hyperspectral image 105, image data may be generated that identifies for each of multiple position and for each of multiple wavelength bands, an intensity, a power, a reflectance, a transmittance, an absorbance, and a trans-reflectance. The image data can be sent over a network 120 to the computing system 125, which can then process the image data (e.g., to potentially perform segmentation, generate image embedding, to identify a sorting instruction for individual objects or groups of objects based on the classification of material category. In the example of FIG. 1, the camera system 110 includes or can be associated with a computer or other device that can communicate over the network 120 with the computing system 125 that processes the hyperspectral image 105 or image data and returns segmented images, embedded representation (or image embedding), or other data by utilizing the embedded representation such as material composition or classification results. In other implementations, the functions of the computing system 125 (e.g., to generate profiles, to process the hyperspectral image 105, to perform classification using embeddings, etc.) can be performed locally at the location of the camera system 110. For example, system 100 can be implemented as a standalone unit that houses the camera system 110 and the computing system 125.

The network 120 can include a local area network (LAN), a wide area network (WAN), the Internet or a combination thereof. Network 120 can also comprise any type of wired and/or wireless network, satellite networks, cable networks, Wi-Fi networks, mobile communications networks (e.g., 3G, 4G, and so forth) or any combination thereof. Network 120 can utilize communications protocols, including packet-based and/or datagram-based protocols such as internet protocol (IP), transmission control protocol (TCP), user datagram protocol (UDP), or other types of protocols. The network 120 can further include a number of devices that facilitate network communications and/or form a hardware basis for the networks, such as switches, routers, gateways, access points, firewalls, base stations, repeaters, or a combination thereof.

The computing system 125 can be configured to use one or more techniques and/or one or more models (e.g., one or more machine-learning models) to process the hyperspectral image 105 or image data. The one or more models may include (for example) a neural network, convolutional neural network, deep neural network, clustering algorithm, etc.

In some instances, the computing system 125 may use a technique (e.g., another technique) or a machine learning model (e.g., another machine-learning model) to generate for a given object a composition prediction data and/or a material category or type classification. The other model may include (for example) a neural network, convolutional neural network, deep neural network, regression model, support vector machine, component analysis (e.g., principal component analysis), etc.

The machine learning model may predict, for example, an amount of a given material in the object or collection, whether the object or collection includes at least a threshold amount of the given material, whether a condition (e.g., pertaining to a composition having at least a first threshold amount of one material and having less than a second threshold amount of another material) is satisfied, etc. The composition prediction data (also referred herein as predicted contribution variable) can associate for each individually segmented object or for a collection of full and/or partial objects that were imaged in the hyperspectral image 105. The predicted contribution variable may indicate whether a given material or chemical is present in objects depicted in at least part of the image. The predicted contribution variable may also indicate a relative or absolute amount of the given material or chemical in the objects depicted in at least part of the image.

The composition prediction data may be generated by transforming part or all of the image data using disclosed techniques in the present disclosure. For example, segmentation analysis may predict that a first particular area represents data from a single object. The wavelength data that corresponds to the first particular area can then be used to generate embeddings and to generate a prediction corresponding to an amount of one or more materials in the single object based on the machine-learning model. As another example, segmentation need not be performed, and wavelength data from a complete image may be fed to the disclosed technique or machine-learning model.

The system 100 may further include one or more database(s) 130 for storing and future processing of unlabeled hyperspectral images or image data (e.g., the hyperspectral image 105 of the waste steam or feedstock). Moreover, the segmentation data, embedded representation, composition prediction data and/or material category classification results can also be stored in the one or more database(s) 130 or other data storage, in association with the hyperspectral image 105 captured. The one or more database(s) 130 may further be used to store unlabeled large dataset of hyperspectral images, small, labeled dataset for supervised fine-tuning of the embedding model, DSC results of multilayer plastics having different concentrations or amount of EVOH.

Computing system 125 can use the composition prediction data to generate one or more action instructions. An action instruction may include routing or facilitating a routing (e.g., a physical routing) of one or more objects. The routing may include routing the object(s) to or away from a given processing line or storage bin. Routing the object(s) may include (for example) moving one or more robotic arms or a sorting machine 135. FIG. 1 illustrates an instance where each of a set of objects represented in the image data is routed to one of storage bins 140a-d based on the corresponding action instruction. In the example instance, objects (or object groups) are sorted into storage bins 140 based on at least a threshold predicted amount (e.g., an absolute or percentage threshold amount) of one or more target materials.

Given the large variety of objects (e.g., plastic products) that may be received in initial feedstocks. For example, each plastic object may include different percent compositions of one or more of: polyvinyl chloride (PVC), polyethylene terephthalate (PET), Low Density Polyethylene (LDPE), High Density Polyethylene (HDPE), polypropylene (PP) and polystyrene (PS). The system 100 can perform optical sorting using hyperspectral imaging to separate recyclable plastics or materials from other objects, as well as to sort plastics by resin type, by level or type of contamination, and/or by presence or concentration of EVOH. Based on processing of the hyperspectral image 105, the system 100 may sort items in the waste stream into different bins 140a-140d. For example, a sorting machine 135 can be operated based on the processing of the hyperspectral image 105 to sort objects into bins such as for plastics with EVOH polymer (bin 140a), for recyclable plastic items (bin 140b), for fibers or cardboard objects (bin 140c), and for metal items (bin 140d). Of course, instead of storing items in bins, the sorted output streams may optionally be sent on different conveyors to be directly processed through appropriate recycling processes such as chemical or mechanical recycling. Therefore, individual objects and/or individual sets of objects may be dynamically routed based on the prediction of an embeddings-based machine-learning algorithm that predicts composition attributes of objects and/or classify object category.

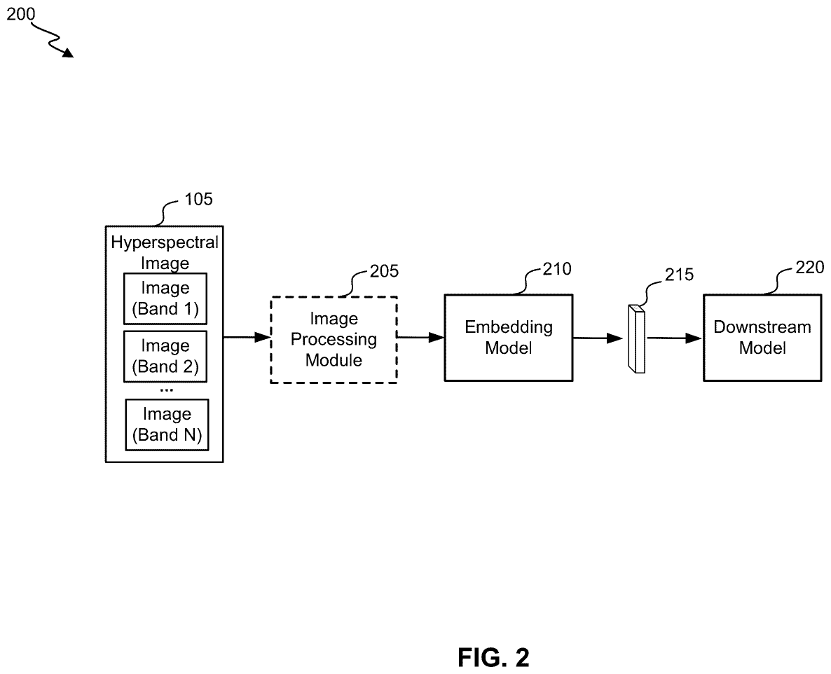

FIG. 2 illustrates an example pipeline 200 to process the hyperspectral image 105 to achieve distillation of information and dimension reduction for a downstream model 220 in accordance with some embodiments of the present disclosure. In some instances, an image processing module 205, which is optional, can be used for the selection of bands from the hyperspectral image 105 that lead to efficient and improved detection of specific materials. In some other instances, an embedding model 210 may be used to generate embedded representation (or hyperspectral image embedding 215) of the hyperspectral image 105 or a processed image from the image processing module 205.

Hyperspectral images-which provide image data about a subject for multiple bands of light that differ in wavelength (e.g., ‘wavelength bands’, ‘spectral bands’, or simply ‘bands’)—include significantly more information than traditional color or greyscale images. Typically, not all of the wavelength bands of hyperspectral images are relevant to each type of boundary or material to be segmented. As a result, depending on the type of object imaged and its properties (e.g., material, composition, structure, texture, etc.), image data for different hyperspectral wavelength bands may be indicative of region boundaries. Similarly, for some object types and region types, information for some wavelength bands may add noise or obscure the desired boundaries, reducing accuracy of segmentation or material detection, and increasing the computational cost of segmentation analysis.

Thus, in some instances, a band selection technique may be performed using the image processing module 205, which may include (for example) one or more actions disclosed in U.S. application Ser. No. 17/811,766, which was filed on Jul. 11, 2022, and which is hereby incorporated by reference in its entirety for all purposes. The band selection technique may generate specific segmentation profiles that specify the different combinations of wavelength bands to provide accurate and efficient detection and/or segmentation of different object types and region types and/or that provide accurate and efficient characterization of depicted objects. Using these profiles, the system can selectively use the image data in images (e.g., hyperspectral, and/or visible-light images) so that different combinations of the image bands are used for locating distinct types of regions or types of boundaries in the images.

In some implementations, synthetic bands or altered bands can also be generated. The synthetic bands can be generated by processing the image data for one or more of the bands selected in a first iteration. For example, each band within the subset of bands can undergo one or more operations (e.g., image processing operations, mathematical operations, etc.), which can include one or more operations that combine data from two or more different bands (e.g., of those selected in the first iteration). Each of various predetermined functions can be applied to the image data for different combinations of the selected bands (e.g., for each pair of bands or each permutation within the selected subset of bands). This can create a new set of synthetic bands each representing a different modification to or combination of bands selected in the first iteration. The synthetic bands can (for example) additionally or alternatively be derived from convolutions or projections applied to the image data, which are functions that map a group of pixels and single pixels, respectively, to single numbers. A single convolution, multiple convolutions, a single projection, and/or multiple projections can be applied across the whole image to create new synthetic bands.

One or more original and/or one or more synthetic bands can be evaluated and/or scored to determine the level to which they are predicted to provide information regarding a target material of interest (e.g., EVOH, metal, fibers etc.). For example, the band(s) can be evaluated and/or scored based on an extent to which intensities within the bands are predictive of whether and/or an extent to which a corresponding depicted object or a corresponding group of objects included a particular type of material. The selected bands may then subsequently be used to analyze other images, for example, using an embedding based classifier to predict contribution variable indicative of absolute or relative quantity of distinct types of materials (e.g., plastics, EVOH, metal, fibers etc.).

In some instances, the image processing module 205 may perform the segmentation using a trained segmentation machine learning model and/or one or more segmentation profiles (e.g., which may indicate different hyperspectral data combinations that correspond to distinct types of materials). The computing system 125 may also store the segmentation data that identifies the portions of the imaged data that are predicted to correspond to various distinct objects.

It will be appreciated that the computing system 125 may not perform a segmentation analysis and/or use a segmentation machine-learning model. For example, hyperspectral data may be collected across the complete extent of one or more axes in the imaging data, which may then be processed directly using the embedding model 210 (e.g., even if it corresponds to a depiction of multiple objects, portions of objects etc.) to generate hyperspectral image embedding 215 for a downstream model 220.

According to some aspects of the present disclosure, generation of large, labeled dataset for supervised training of one or more machine learning models for various downstream tasks or processes is usually not feasible due to time and resource constraints. For example, quantifying the presence of EVOH in a piece of plastic is time consuming, as each sample is analyzed using differential scanning calorimetry (DSC), which, in this case, takes around one hour per piece of plastic. Therefore, according to present disclosure, the embedding model 210 may be used to generate hyperspectral image embedding 215 (or embedded representations), The embedding model 210 can be a deep learning model or convolutional neural network (CNN) based model, which is trained in a self-supervised setting using a reward or loss function (e.g., contrastive loss). Self-supervised learning is a family of techniques to convert an unsupervised learning problem into a supervised one by creating surrogate labels automatically from the unlabeled dataset. Once the embedding model 210 is trained on large unlabeled dataset of hyperspectral images or image data obtained from the camera system 110, the model can be fine-tuned using a small, labeled dataset for a specific problem. Afterwards, the embedding model 210 can be used to generate embedded representations that have reduced dimensions and provide information distillation for the specific problem.

In some embodiments, the embedding model 210 may be used to identify potential training examples for a particular task. For example, a small, labeled dataset of images associated with the particular task may be processed using the embedding model 210 to generate corresponding embedded representations. Afterwards, a new image (e.g., received from the camera system 110) can be converted into embedded representation. The embedded representation may comprise a vector of floating point or integer values and can be represented in an embedding space. A similarity measure can be computed, for example using distance metrics such as Euclidean distance, Mahalanobis distance, or cosine similarity, between embedded representations of the particular task and the embedded representation of the new image. Based on the similarity measure, the new image can be selected or discarded for the training set of the particular task.

In some other embodiments, a selective use of information from the hyperspectral image 105 (e.g., by using the hyperspectral image embedding 215) can provide higher accuracy in predictions as well as faster, computationally less-intensive downstream model(s) 220. Based on the embedded representations, a simple and accurate downstream model 220 can be trained using a small dataset. The downstream model 220 can be any machine learning model (including regression and classification techniques) to perform a given or a specific task, for example, material category or type classification, prediction of absolute or relative quantity of a target material of interest (e.g., EVOH) etc. within a hyperspectral image 105.

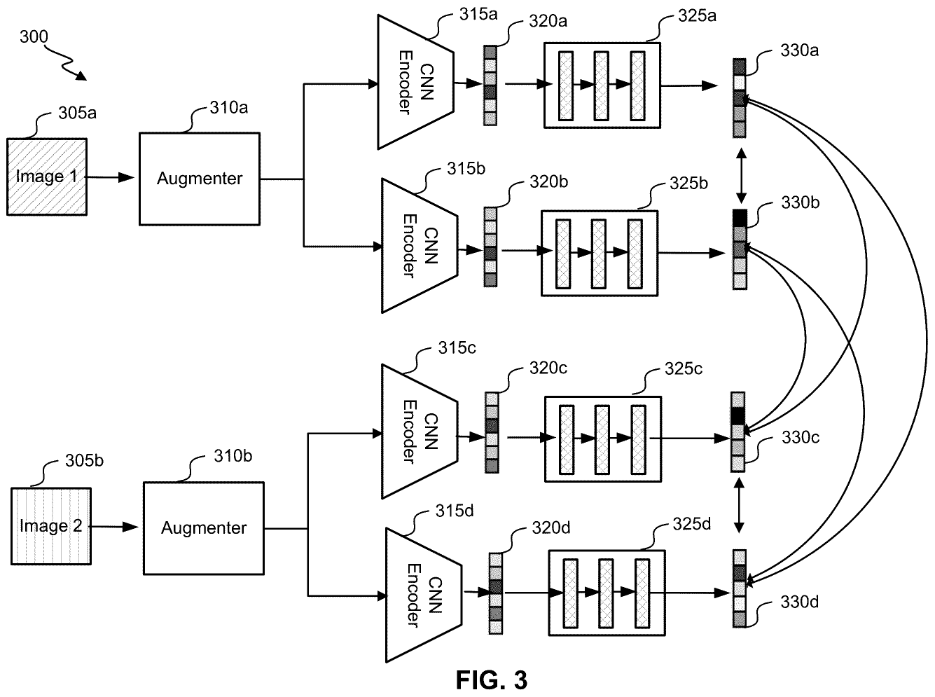

FIG. 3 shows an example illustration 300 of self-supervised training or pretraining of the embedding model 210 using a large unlabeled dataset of images in accordance with some embodiments of the present disclosure. The example illustration 300 represents a simple framework for contrastive learning (SimCLR) of visual representations, which is illustrated at https://github.com/google-research/simclr, and is hereby incorporated by reference for all purposes.

SimCLR initially learns general representations of images from an unlabeled dataset, which can later be fine-tuned with a limited number of labeled images to perform well on a specific classification task. The process of learning these representations 320a-d (or nonlinear projections 330a-d) involves contrastive learning, where the model simultaneously maximizes the similarity between different views of the same image (e.g., image 1 305a or image 2 305b) and minimizes the similarity between views of different images (e.g., image 1 305a and image 2 305b). By updating the neural network's parameters (e.g., CNN encoder 315 and multilayer perceptron MLP 325) based on this contrastive objective, the model drives the representations of corresponding views to converge (e.g., 330a and 330b, or 330c and 330d), while pushing apart the representations of non-corresponding views (e.g., 330b and 330c, or 330b and 330d, etc.).

During the self-supervised pretraining, at first, images (e.g., image 1 305a, or image 2 305b) are selected randomly from the original dataset. An augmenter 310 may apply one or more different augmentations to each image (305a-b), including random cropping, color distortion, and Gaussian blur. This results in two distinct yet related views of each image (305a-b). The purpose of these transformations is threefold: first, to promote consistent representations of the same image under various transformations; second, to address the absence of labels in the pretraining data, preventing the need for explicit class identification; and third, to demonstrate that these simple augmentations are good enough for the neural net (e.g., CNN encoder 315 and MLP 325) to learn robust representations, although more complex transformation strategies can also be used.

Afterwards, the CNN encoder 315, for example, based on the ResNet architecture, may be used to compute a representation of the input image (e.g., image 1 305a or image 2 305b) augmentations. Following this, a fully connected network, specifically the multilayer perceptron (MLP 325), projects the image representation non-linearly (i.e., non-linear projections 330a-d), enhancing the model's ability to distinguish different transformations of the same image. The CNN encoder 315 and MLP 325 parameters are optimized using stochastic gradient descent to minimize the contrastive loss function. After pretraining on the unlabeled dataset, the embedding model 210 can either use the CNN encoder 315 output, or output from any one of the initial layers (or any hidden layer) of the MLP 325, as the image representation in the embedding space.

The CNN encoder 315 and the MLP 325 layers are trained concurrently to produce projections that are similar for augmented versions of the same image, while ensuring dissimilarity between projections of different images, even if those images belong to the same object class. As a result, the trained model excels at recognizing various transformations of the same image and also develops representations that capture similar concepts (e.g., distinguishing chairs from dogs, or metals from plastics etc.), which can subsequently be linked to labels through fine-tuning.

In some instances, self-supervised pre-training of the embedding model 210 may be performed on using the large unlabeled dataset of hyperspectral images. In some other instances, a pretrained model on the RGB images may be adapted and fine-tuned on the large unlabeled dataset of hyperspectral images. Further, the embedding model 210 may be comprised of the CNN encoder 315 alone or in some instances, the CNN encoder 315 together with the MLP 325. In the example illustration 300, four parallel branches or instances of the CNN encoder (315a-d) and the MLP (325a-d) are shown for better understanding. In real implementation, both sequential executions (e.g., using single instance of the CNN encoder 315 and the MLP 325) and parallel executions (e.g., as illustrated in FIG. 3) are possible.

According to some embodiments, after learning general representations via unsupervised or self-supervised pretraining on a large unlabeled dataset, the general representations are then adapted for a specific task via supervised fine-tuning of the embedding model 210 on a small fraction of data that has class labels. The supervised fine-tuning may adapt a task-agnostically pretrained network (e.g., self-supervised pretrained embedding model) for a specific task. Moreover, to further improve the network (or the model) for the specific task and to reduce the network (or the model) size, the fine-tuned network (or the model) can be used as a teacher to impute labels for training a student network using the large unlabeled dataset, for example, by using techniques such as SimCLRv2 (sec arXiv: 2006.10029, available at https://arxiv.org/abs/2006.10029, which is hereby incorporated by its entirety for all purposes).

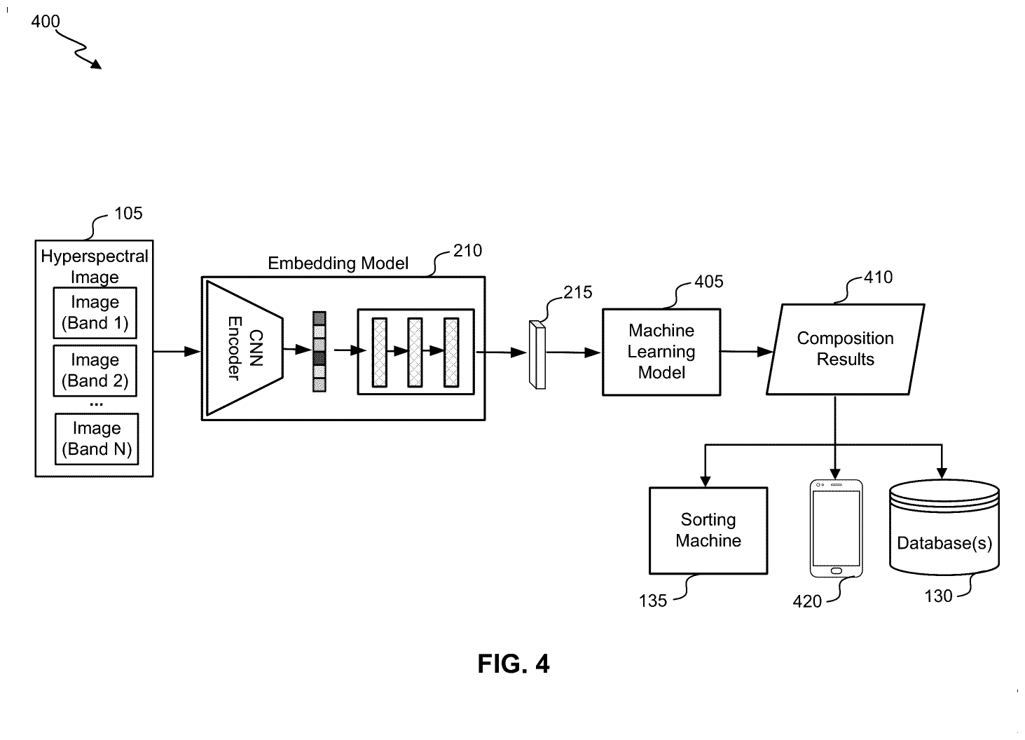

FIG. 4 shows an illustrative example of a system for predicting the material category or composition of an object based on the hyperspectral image 105 of the object in accordance with some embodiments of the present disclosure. The hyperspectral image 105 may include multiple images (e.g., image 1, image 2 . . . image N) representing the spatial dimensions, where each of the images has a different wavelength and/or band (e.g., Band 1, Band 2 . . . Band N). A selective use of information from the hyperspectral image 105 can provide higher accuracy in predictions as well as faster, less-computationally intense models for a specific task. The embedding model 210, which undergoes self-supervised pre-training followed by a supervised fine-tuning, may be used to generate the hyperspectral image embedding 215.

The embedding model 210 can be used to generate representations (or embedded representations) of hyperspectral images from a set of training examples for the specific task. A machine learning model 405 may be trained based on the representations to classify an item or a set of items as recyclable or not through detection of the material type and/or quantity. The machine learning model 405 may include regression (e.g., linear regression, lasso regression, polynomial regression, support vector regression, neural networks, etc.), or classification techniques (nearest neighbors, support vector machines, logistic regression, neural networks, etc.). The machine learning model 405 may also include but not limited to a recurrent neural network (RNN), a long short-term memory (LSTM) model, a transformer model, neural networks (NNs), multi-value prediction algorithm, deep learning models, or regression techniques.

The output of the machine learning model 405, is referred herein as composition results 410, can be a number (e.g., absolute value or relative percentage) representing the quantity or concentration of the target material of interest (e.g., EVOH). In some instances, the output can be a binary value (indicating recyclable or not), or a category (e.g., plastic, metal, fiber etc.).

According to some embodiments, the machine learning model 405 may be used to detect a presence or absence and/or relative or absolute quantity of EVOH in an image of multilayer plastics. EVOH or Ethylene Vinyl Alcohol is a polymer material that is often used in multilayered plastic packaging, particularly in food packaging. EVOH is highly effective at preventing the passage of oxygen, moisture, and other gases. This makes it particularly valuable in food packaging, where it helps preserve the freshness and quality of products. EVOH is usually used in thin layers within multilayered plastic structures. When plastics are recycled, it can be difficult to separate EVOH from the other materials in the multilayer packaging. The different polymers may not bond well with each other during the recycling process, making it challenging to recover and reuse the EVOH layer effectively. The presence of EVOH in the recycling stream can lead to contamination, as it may not easily break down into its original components during traditional recycling processes. This contamination can degrade the quality of the recycled material, making it less desirable for reuse. Therefore, the recycling of EVOH-containing plastics is often avoided, leading to these materials being discarded instead of recycled.

Therefore, it would be valuable to build the machine learning model 405 for EVOH classification. However, quantifying the presence of EVOH in a piece of plastic is time consuming, as each sample is analyzed using differential scanning calorimetry (DSC), which, in this case, takes around one hour per piece of plastic. Thus, collecting labeled training data for an EVOH classification model is an expensive prospect, increasing the need for an efficient method of identifying promising pieces of plastic to add to the training set. Furthermore, it is not evident, visually, which samples do and do not contain EVOH.

According to present disclosure, the embedding model 210 can be used to identify additional samples for labeling (e.g., via DSC) from the images of objects on the waste stream or the feedstock. This is accomplished by embedding the images of a small set of known EVOH samples (e.g., based on DSC results), embedding other (e.g., tens of thousands) of other unlabeled images corresponding to other pieces of plastic, and ranking the unlabeled images based on their embeddings' proximity to the embeddings of known EVOH samples.

After identification of additional samples for labeling based on the embeddings, a labeled training set for EVOH classification can be generated. The embeddings of the labeled training set (e.g., generated by the embedding model 210) can then be used to train the EVOH classification model itself. Hence, a simple and accurate linear classifier (or the EVOH classification model or the machine learning model 405) can be built on top of these embeddings. Moreover, the machine learning model 405 can be trained within minutes due to reduced dimensions in the embedded representations as compared to using the full image data.

In some other embodiments, the computing system 125 may obtain a set of training images. The set of training images may be comprised of hyperspectral images of diverse types of plastics, metals, fibers, or other recyclable items to be analyzed. Each hyperspectral image 105 in the set of training images can be associated with a ground truth label indicating the actual properties of the item imaged. For example, the ground truth labels can include information for any of the properties that the models will be trained to predict, such as resin type, material type, whether a particular material is present, the amount or concentration of the particular material, and so on. The information in the ground truth labels can be determined through testing of the samples imaged, or by looking up characteristics of the materials from manufacturing data or reference data for the types of objects imaged. To allow for training of a robust model, the training images can include images of waste products on the feedstock, taken with different camera systems, different illumination levels, different distances of camera to object, different orientations or poses of samples, and so on. The training images can be converted into embedded representations using the embedding model 210 for training the machine learning model 405 based on the image embeddings.

In some instances, different models can be generated and trained to predict different properties or concentration of different types of materials. For example, in some implementations, one machine learning model may be trained for each type of material to predict its absolute or relative percentage in the object depicted by the hyperspectral image 105. In some other instances, a single model may be trained to classify different materials categories or to estimate relative contribution of each material based on the hyperspectral image embedding 215. Furthermore, in some other instances, the bands used to generate embedded representation of the hyperspectral image 105 for the machine learning model 405 (or each model) can be selected for better identification of the material of interest (e.g., metal, fiber, EVOH) and, in some cases, to improve distinguishing from the presence of other materials that are frequently present (e.g., various types of plastics).

After the machine learning model 405 (or models) is trained, the model can be used to make predictions for objects based on images of the objects and to generate the composition results 410. The composition results may comprise the composition prediction data or the predicted contribution variable that indicates presence or absence of different materials and the quantity (in absolute or relative terms) of different materials that are present in the image. The composition results 410 can be used to characterize waste items or a stream of waste material.

In the example implementation, the predicted material type and/or quantity may be assessed by the computing system 125 or another device and can be used to sort the objects in the waste stream. For example, the material quantity can be compared with one or more thresholds that correspond to different storage bins 140a-d, or other output streams. The predictions can then be used by the computing system 125 or another system to control sorting equipment, such as the sorting machine 135, that is configured to move objects to different areas or containers (e.g., storage bins 140a-d). Different categories of objects (e.g., groups having different chemical properties) can be processed differently for mechanical or chemical recycling.

According to some aspects of the present disclosure, the composition results 410 may be provided to a device. For example, the composition results 410 (or composition prediction data) can be stored in the one or more database(s) 130 or other data storage, in association with a sample identifier, time stamp, and potentially context data such as a sample type, location, etc. As a result, individual objects can be tagged or associated with metadata that indicates the material type and/or quantity (e.g., chemicals or materials present, the amounts, or concentrations of the materials, etc.) as estimated using the machine learning model 405 (or models). As another example, the composition prediction data can be provided to one or more user devices 420, such as a smartphone, laptop computer, desktop computer, etc., for presentation to a user in a user interface.

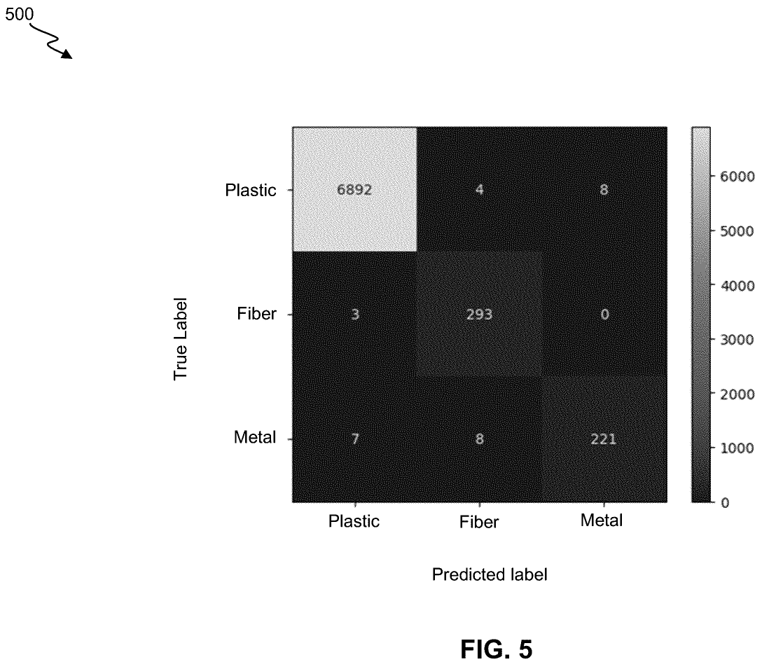

FIG. 5 shows a confusion matrix 500 indicating performance of the machine learning model 405 for classification of material category or type in accordance with an example implementation of the present disclosure. In the example implementation, images, or hyperspectral images of objects of known material category were embedded using the embedding model 210, and then a simple material-category classifier was built based on these embeddings. The confusion matrix 500 was generated using the validation set. The confusion matrix 500 illustrates the performance of the machine learning model 405 in a three-class classification problem involving the categories: Plastic, Fiber, and Metal. The rows of the matrix represent the actual class labels, while the columns represent the predicted class labels. For classifying Plastic, the model correctly predicted 6,892 instances (true positives) but misclassified 4 as Fiber and 8 as Metal. For Fiber, 293 instances were correctly classified, while 3 were misclassified as Plastic and none as Metal. Finally, for Metal, the model correctly identified 221 instances but misclassified 7 as Plastic and 8 as Fiber. The confusion matrix 500 reflects the model's overall ability to distinguish between these materials, showing a high number of true positives and relatively few misclassifications, indicating strong performance overall.

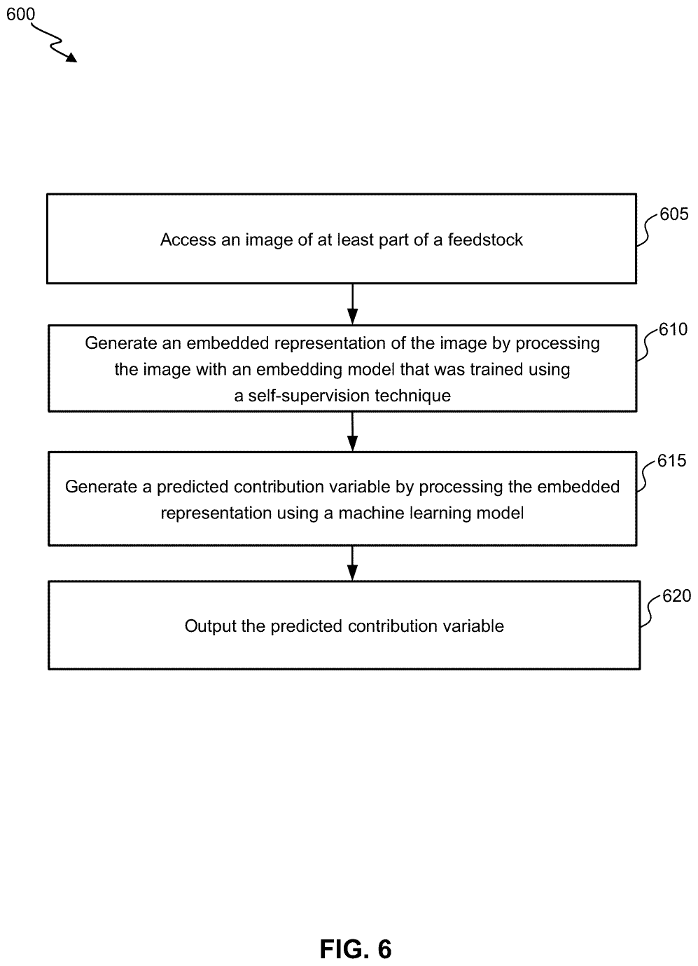

FIG. 6 shows an example flowchart of a system for detecting a given material and/or predicting a contribution of the given material in an image of a feedstock in accordance with some embodiments of the present disclosure. The blocks in flowchart 600 can be performed by hardware or software or a combination thereof. The process at block 605 may include accessing an image of at least part of a feedstock. The image may correspond to a hyperspectral image 105 that is collected using the camera system 110.

An embedded representation of the image may be generated by processing the image with the embedding model 210, at block 610. The axes of the embedded representation in the embedding space can be identified during a training process of the embedding model 210. The training process uses a self-supervision technique that may process multiple portions of various images in a training data set and that may use a reward function. The reward function may be configured such that a reward correlated with an extent to which various portions from individual images are positioned relatively close to each other as compared to (or relative to) portions from different images in the embedding space.

A predicted contribution variable may be generated by processing the embedded representation using the machine learning model 405, at block 615. The predicted contribution variable may predict whether a given material or chemical is present in objects depicted in at least part of the image. The predicted contribution variable may further predict a relative or absolute amount of the given material or chemical in the objects depicted in at least part of the image. Finally, at block 620, the predicted contribution variable may be output. In some instances, the predicted contribution variable may be utilized by the sorting machine 135 to divert the objects into appropriate storage bins 140.

Some embodiments of the present disclosure include a system including one or more data processors. In some embodiments, the system includes a non-transitory computer-readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification, and variation of the concepts herein disclosed may be resorted to by those skilled in the art, and that such modifications and variations are considered to be within the scope of this invention as defined by the appended claims.

The present description provides preferred exemplary embodiments only, and is not intended to limit the scope, applicability, or configuration of the disclosure. Rather, the description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A computer-implemented method comprising:
accessing an image of at least part of a feedstock;
generating an embedded representation of the image by processing the image with an embedding model, wherein axes of the embedded representation in an embedding space were identified during a training process of the embedding model that used a self-supervision technique, wherein the self-supervision technique processed multiple portions of various images in a training data set and that used a reward function configured such that a reward correlated with an extent to which various portions from individual images were positioned relatively close to each other as compared to or relative to portions from different images in the embedding space;
generating a predicted contribution variable by processing the embedded representation using a machine-learning model, wherein the predicted contribution variable predicts whether a given material or chemical is present in objects depicted in at least part of the image or that predicts a relative or absolute amount of the given material or chemical in the objects depicted in the at least part of the image; and
outputting the predicted contribution variable.

2. The computer-implemented method of claim 1, wherein the machine-learning model includes a linear classifier.

3. The computer-implemented method of claim 1, wherein the given material or chemical includes ethylene vinyl alcohol (EVOH).

4. The computer-implemented method of claim 1, wherein the predicted contribution variable predicts whether the at least part of the feedstock includes plastic or an extent to which the at least part of the feedstock includes plastic.

5. The computer-implemented method of claim 1, wherein the predicted contribution variable predicts whether the at least part of the feedstock includes plastic or an extent to which the at least part of the feedstock includes metal.

6. The computer-implemented method of claim 1, wherein the predicted contribution variable predicts whether the at least part of the feedstock includes plastic or an extent to which the at least part of the feedstock includes fibers.

7. The computer-implemented method of claim 1, wherein the image is a hyperspectral image.

8. A system comprising:
one or more data processors; and
a non-transitory computer-readable storage medium containing instructions which, when executed on the one or more data processors, cause the one or more data processors to perform a set of operations including:
accessing an image of at least part of a feedstock;
generating an embedded representation of the image by processing the image with an embedding model, wherein axes of the embedded representation in an embedding space were identified during a training process of the embedding model that used a self-supervision technique, wherein the self-supervision technique processed multiple portions of various images in a training data set and that used a reward function configured such that a reward correlated with an extent to which various portions from individual images were positioned relatively close to each other as compared to or relative to portions from different images in the embedding space;
generating a predicted contribution variable by processing the embedded representation using a machine-learning model, wherein the predicted contribution variable predicts whether a given material or chemical is present in objects depicted in at least part of the image or that predicts a relative or absolute amount of the given material or chemical in the objects depicted in the at least part of the image; and
outputting the predicted contribution variable.

9. The system of claim 8, wherein the machine-learning model includes a linear classifier.

10. The system of claim 8, wherein the given material or chemical includes ethylene vinyl alcohol.

11. The system of claim 8, wherein the predicted contribution variable predicts whether the at least part of the feedstock includes plastic or an extent to which the at least part of the feedstock includes plastic.

12. The system of claim 8, wherein the predicted contribution variable predicts whether the at least part of the feedstock includes plastic or an extent to which the at least part of the feedstock includes metal.

13. The system of claim 8, wherein the predicted contribution variable predicts whether the at least part of the feedstock includes plastic or an extent to which the at least part of the feedstock includes fibers.

14. The system of claim 8, wherein the image is a hyperspectral image.

15. A computer-program product tangibly embodied in a non-transitory machine-readable storage medium, including instructions configured to cause one or more data processors to perform a set of operations comprising:
accessing an image of at least part of a feedstock;
generating an embedded representation of the image by processing the image with an embedding model, wherein axes of the embedded representation in an embedding space were identified during a training process of the embedding model that used a self-supervision technique, wherein the self-supervision technique processed multiple portions of various images in a training data set and that used a reward function configured such that a reward correlated with an extent to which various portions from individual images were positioned relatively close to each other as compared to or relative to portions from different images in the embedding space;
generating a predicted contribution variable by processing the embedded representation using a machine-learning model, wherein the predicted contribution variable predicts whether a given material or chemical is present in objects depicted in at least part of the image or that predicts a relative or absolute amount of the given material or chemical in the objects depicted in the at least part of the image; and
outputting the predicted contribution variable.

16. The computer-program product of claim 15, wherein the machine-learning model includes a linear classifier.

17. The computer-program product of claim 15, wherein the given material or chemical includes ethylene vinyl alcohol.

18. The computer-program product of claim 15, wherein the predicted contribution variable predicts whether the at least part of the feedstock includes plastic or an extent to which the at least part of the feedstock includes plastic.

19. The computer-program product of claim 15, wherein the predicted contribution variable predicts whether the at least part of the feedstock includes plastic or an extent to which the at least part of the feedstock includes metal.

20. The computer-program product of claim 15, wherein the predicted contribution variable predicts whether the at least part of the feedstock includes plastic or an extent to which the at least part of the feedstock includes fibers.
